(19) United States
(12) Patent Application Publication
(10) Pub. No.: US 2016/0357302 A1
(43) Pub. Date: Dec. 8, 2016

(54) SCAN METHOD OF TOUCH SIGNAL

(71) Applicant: Wuhan China Star Optoelectronics Technology Co., Ltd., Wuhan City (CN)

(72) Inventors: Jianxing Xie, Wuhan City (CN); Qingcheng Zuo, Wuhan City (CN)

(21) Appl. No.: 14/771,504

(22) PCT Filed: Jun. 25, 2015
(86) PCT No.: PCT/CN2015/082266

§ 371 Date: Aug. 31, 2015

(30) Foreign Application Priority Data
Jun. 2, 2015 (CN) 201510295392.3

(51) Int. Cl. G06F 3/041; G06F 3/044

(52) U.S. Cl. CPC G06F 3/0416; G06F 3/0412; G06F 3/044

(57) ABSTRACT

The present invention provides a scan method of a touch signal. The different scan pulse signals with an amount corresponding to a plurality of driving lines are employed to perform scan simultaneously, and a corresponding coding is performed to each scan pulse signal; meanwhile, each of a plurality of receiving lines synchronously receives all the scan pulse signals, and a control chip is employed to decode the receiving signal received by each receiving line to determine the sources of the different signal segments in the receiving signal; as the finger touches, it is determined that the driving line corresponding to the number of the scan pulse signal is touched by the finger, and with combination of the receiving line corresponded with the receiving signal of the signal segment, of which the signal value becomes smaller, an touch position is acquired. The method can decrease an occupied period of performing scan to a touch signal by an In Cell touch control display device to increase the period of display signal scan for urging the In Cell touch control display device to be developed with higher resolution.

### FIELD OF THE INVENTION

The present invention relates to a touch display technology field, and more particularly to a scan method of a touch signal.

### BACKGROUND OF THE INVENTION

With the development of display technology, the flat panel device, such as Liquid Crystal Display (LCD) possesses advantages of high image quality, power saving, thin body and wide application scope. Thus, it has been widely applied in various consumer electrical products, such as mobile phone, television, personal digital assistant, digital camera, notebook, laptop, and becomes the major display device.

Touch panel provides a new human machine interactive interface. The usage is more direct and with more humanization. Forming a touch control device with combining the touch panel and the flat display device is capable of providing the touch control function to the flat display device. With the fingers, the stylus for inputting, the operation can be more intuitive and easy.

At present, the liquid display panel and touch control panel have been widely applied and accepted, used by the people. Meanwhile, it has replaced the traditional CRTs and physical push button input devices. The initial touch display devices generally utilize the independent type touch control screen, which the touch control panel and the liquid crystal display panel are separately manufactured, and then combined with assembly. The touch display device obtained by this manufacture solution is thicker. With the additional glass, thin film, the transmission rate and the contrast of the liquid crystal panel obviously descend, either. Meanwhile, the manufacture cost is higher because of the separate manufacture. The market competitiveness goes down.

For solving the aforesaid problem and providing a touch control display device, which is thinner, with better display effect and lower cost, an embedded touch control technology emerges as the time requires. The embedded touch control technology is to combine the touch control panel and the display panel as one, and to merge the function of the touch control panel into the liquid crystal panel to make the liquid crystal panel equipped with functions of display and sensing the touch control inputs at the same time.

The present embedded touch control technology can be categorized into two types: one is that the touch control circuit is on the liquid crystal cell (On Cell), and the other is that the touch control circuit is inside the liquid crystal cell (In Cell). With the competitions in the smart phone market gets more intense, touch control and display integrated product has rapidly developed. In Cell technology is considered to be the high end technology of the touch control display field. However, most of the present In Cell touch control display panel utilize the time-sharing driver, which the display driving and the touch control driving are independently performed in separated periods. In a first duration of the one cycle (generally a display period of one frame image), only the scan operation to the display signal is performed, and then, in the rest duration of the cycle, the scan operation to the touch control signal is performed. Moreover, the scan to the mutual capacitance signal is generally performed row-by-row. The more the amount of the row is, the occupied period of scan to the touch control signal becomes longer. With the resolution of the product becomes higher, the required period of the scan to the display signal gets longer and longer. The necessary period of the scan to the corresponding touch control signal is compressed. The situation that the scan period of the touch control signal is not enough occurs and restricts the development of the product.

Therefore, the occupied period of the scan to the touch control signal has to be shortened to increase the scan period to the display signal for meeting the trend of development of the touch control display device with high resolution.

### SUMMARY OF THE INVENTION

An objective of the present invention is to provide a scan method of a touch signal, which can decrease an occupied period of performing scan to a touch signal by an In Cell touch control display device to increase the period of display signal scan for urging the In Cell touch control display device to be developed with higher resolution.

For realizing the aforesaid objective, the present invention provides a scan method of a touch signal, comprising steps of:

step 1, providing a touch display panel;

the touch display panel comprises m horizontal driving lines which are parallel with one another and sequentially aligned, and n vertical receiving lines which are parallel with one another and sequentially aligned, wherein both m, n are integers larger than 2;

step 2, employing a signal generator to simultaneously generate a different scan pulse signals to perform scan to the a driving lines simultaneously, wherein 2≦a≦m, and a falling edge of the scan pulse signal corresponding to the previous driving line and a rising edge of the scan pulse signal corresponding to the next driving line are simultaneously generated, and a corresponding coding is performed to each scan pulse signal;

as the a scan pulse signals perform scan to the a driving lines simultaneously, all the receiving lines synchronously receives all the scan pulse signals provided by the a driving lines to make that each receiving line receives a receiving signal of the same signal value;

step 3, employing a control chip to decode the receiving signal received by each receiving line to acquire numbers of different scan pulse signals corresponding to different signal segment in the receiving signal;

step 4, as a finger touches the touch display panel, according to the numbers of the signal segment, of which the signal value becomes smaller, it is determined that the driving line corresponding to the number of the scan pulse signal is touched by the finger, and with combination of the receiving line corresponded with the receiving signal of the signal segment, of which the signal value becomes smaller, an touch position is acquired.

In the step 2 of the scan method of the touch signal, the scan pulse signal corresponding to ith driving line is numbered to be i, wherein 1≦i≦a.

In the step 2, a sum of pulse durations of all the scan pulse signals is equal to a pulse duration of the receiving signal.

In the step 3 of the scan method of the touch signal, in chronological order, the signal segment number of the scan pulse signal, which is numbered to be i, corresponded with the receiving signal is i.

A specific process of the step 4 of the scan method of the touch signal is: as the finger touches a dot of the ith driving line and yth receiving line, wherein 1≦y≦n, the signal value of the signal segment which is numbered to be i, corresponded with the receiving signal received by the yth receiving line becomes smaller, and with the number i of the signal segment of which the signal value becomes smaller in the received signal, it is determined that what the finger touches is the ith driving signal line correspondingly providing the scan pulse signal, of which the number is i, and with combination of the yth receiving line corresponded with the receiving signal of the signal segment, of which the signal value becomes smaller, an touch position at the dot of the ith driving line and yth receiving line is acquired.

Both the driving lines and the receiving lines are formed at common electrode layer.

The driving lines are formed at common electrode layer, and the receiving lines are formed at another metal layer, which is not the common electrode layer.

The scan pulse signal is a high frequency signal.

The touch display panel is an In Cell type touch display panel.

The touch display panel is a mutual capacitance type touch display panel.

The present invention further provides a scan method of a touch signal, comprising steps of:

step 1, providing a touch display panel;

the touch display panel comprises m horizontal driving lines which are parallel with one another and sequentially aligned, and n vertical receiving lines which are parallel with one another and sequentially aligned, wherein both m, n are integers larger than 2;

step 2, employing a signal generator to simultaneously generate a different scan pulse signals to perform scan to the a driving lines simultaneously, wherein 2≦a≦m, and a falling edge of the scan pulse signal corresponding to the previous driving line and a rising edge of the scan pulse signal corresponding to the next driving line are simultaneously generated, and a corresponding coding is performed to each scan pulse signal;

as the a scan pulse signals perform scan to the a driving lines simultaneously, all the receiving lines synchronously receives all the scan pulse signals provided by the a driving lines to make that each receiving line receives a receiving signal of the same signal value;

step 3, employing a control chip to decode the receiving signal received by each receiving line to acquire numbers of different scan pulse signals corresponding to different signal segment in the receiving signal;

step 4, as a finger touches the touch display panel, according to the numbers of the signal segment, of which the signal value becomes smaller, it is determined that the driving line corresponding to the number of the scan pulse signal is touched by the finger, and with combination of the receiving line corresponded with the receiving signal of the signal segment, of which the signal value becomes smaller, an touch position is acquired;

wherein in the step 2, the scan pulse signal corresponding to ith driving line is numbered to be i, wherein 1≦i≦a;

wherein the touch display panel is an In Cell type touch display panel;

wherein the touch display panel is a mutual capacitance type touch display panel.

The benefits of the present invention are: the present invention provides a scan method of a touch signal. The different scan pulse signals with an amount corresponding to a plurality of driving lines are employed to perform scan simultaneously, and a corresponding coding is performed to each scan pulse signal; meanwhile, each of a plurality of receiving lines synchronously receives all the scan pulse signals provided by the plurality of driving lines, and a control chip is employed to decode the receiving signal received by each of the plurality of receiving lines to determine the sources of the different signal segments in the receiving signal; as the finger touches, it is determined that the driving line corresponding to the number of the scan pulse signal is touched by the finger, and with combination of the receiving line corresponded with the receiving signal of the signal segment, of which the signal value becomes smaller, an touch position is acquired. The method can decrease an occupied period of performing scan to a touch signal by an In Cell touch control display device to increase the period of display signal scan for urging the In Cell touch control display device to be developed with higher resolution.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a diagram of a touch control display panel of a scan method of a touch signal according to the present invention;

FIG. 2 is a waveform diagram of a scan pulse signal of a scan method of a touch signal according to the present invention;

FIG. 3 is a waveform diagram of a receiving signal of a scan method of a touch signal according to the present invention;

FIG. 4 is a waveform diagram of the receiving signal as the scan method of the touch signal according to the present invention is applied to perform touch control;

FIG. 5 is a flowchart of a scan method of a touch signal according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

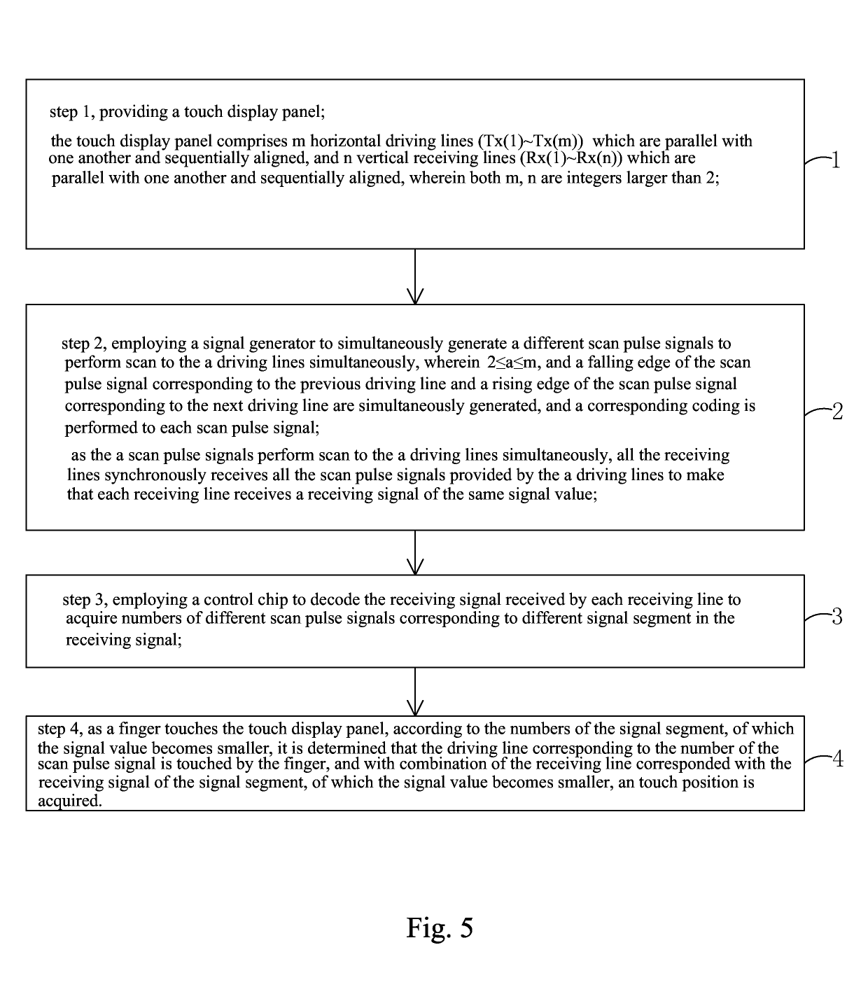

Please refer to FIG. 5. The present invention provides a scan method of a touch signal, comprising steps of:

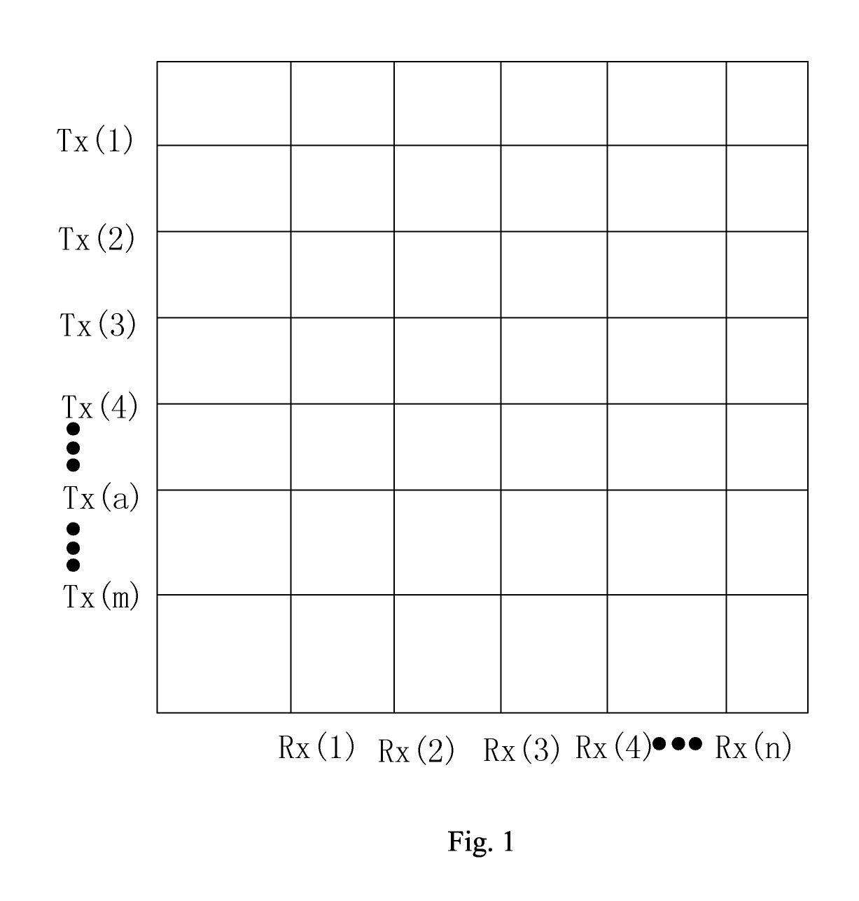

step 1, as shown in FIG. 1, providing a touch display panel.

The touch display panel comprises m horizontal driving lines Tx(1)-Tx(m) which are parallel with one another and sequentially aligned, and n vertical receiving lines Rx(1)-Rx(n) which are parallel with one another and sequentially aligned, wherein both m, n are integers larger than 2.

Specifically, the driving lines Tx(1)-Tx(m) and the receiving lines Rx(1)-Rx(n) can be formed at the same layer. Preferably, both the driving lines Tx(1)-Tx(m) and the receiving lines Rx(1)-Rx(n) are formed at common electrode layer. The driving lines Tx(1)-Tx(m) and the receiving lines Rx(1)-Rx(n) can be formed at different layers, either. Preferably, the driving lines Tx(1)-Tx(m) are formed at common electrode layer, and the receiving lines Rx(1)-Rx(n) at another metal layer, which is not the common electrode layer.

The touch display panel is an In Cell type touch display panel; meanwhile, the touch display panel is a mutual capacitance type touch display panel.

step 2, employing a signal generator to simultaneously generate a different scan pulse signals to perform scan to the a driving lines simultaneously, wherein 2≦a≦m, and a falling edge of the scan pulse signal corresponding to the previous driving line and a rising edge of the scan pulse signal corresponding to the next driving line are simultaneously generated, and a corresponding coding is performed to each scan pulse signal.

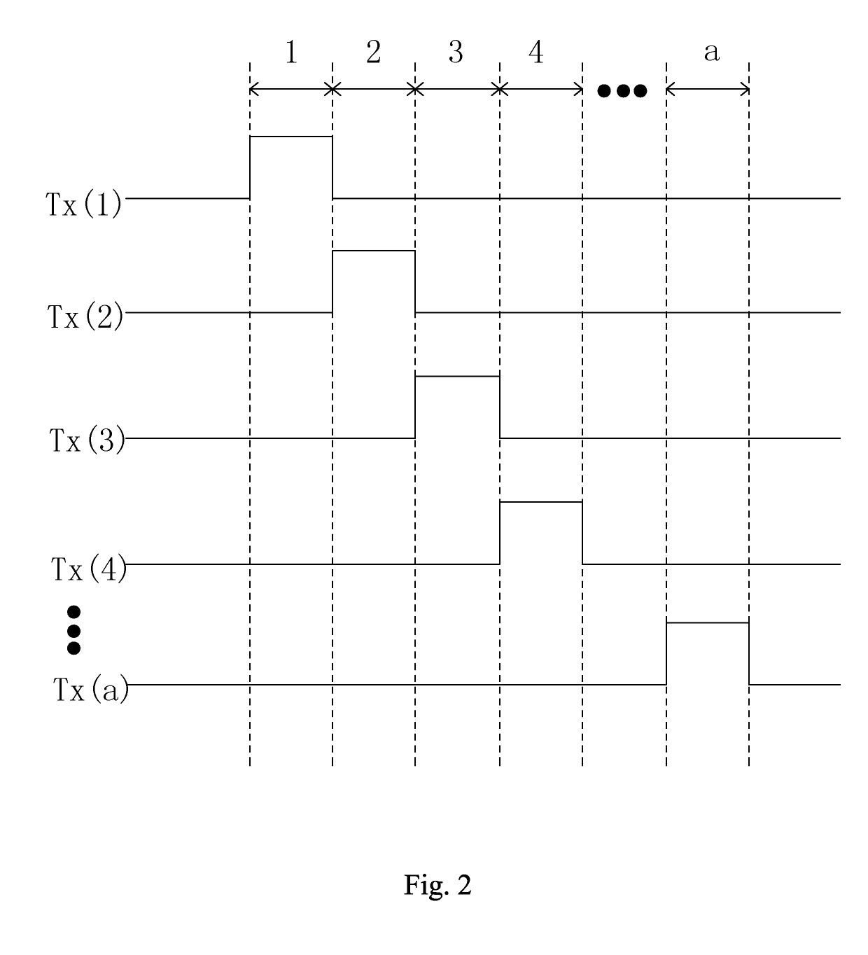

As shown in FIG. 2, the scan pulse signal corresponding to the first driving line Tx(1) is numbered to be 1, and the scan pulse signal corresponding to the second driving line Tx(2) is numbered to be 2, and until the scan pulse signal corresponding to the ath driving line Tx(a) is numbered to be a, i.e. the scan pulse signal corresponding to the ith driving line Tx(i) is numbered to be i, wherein 1≦i≦a;

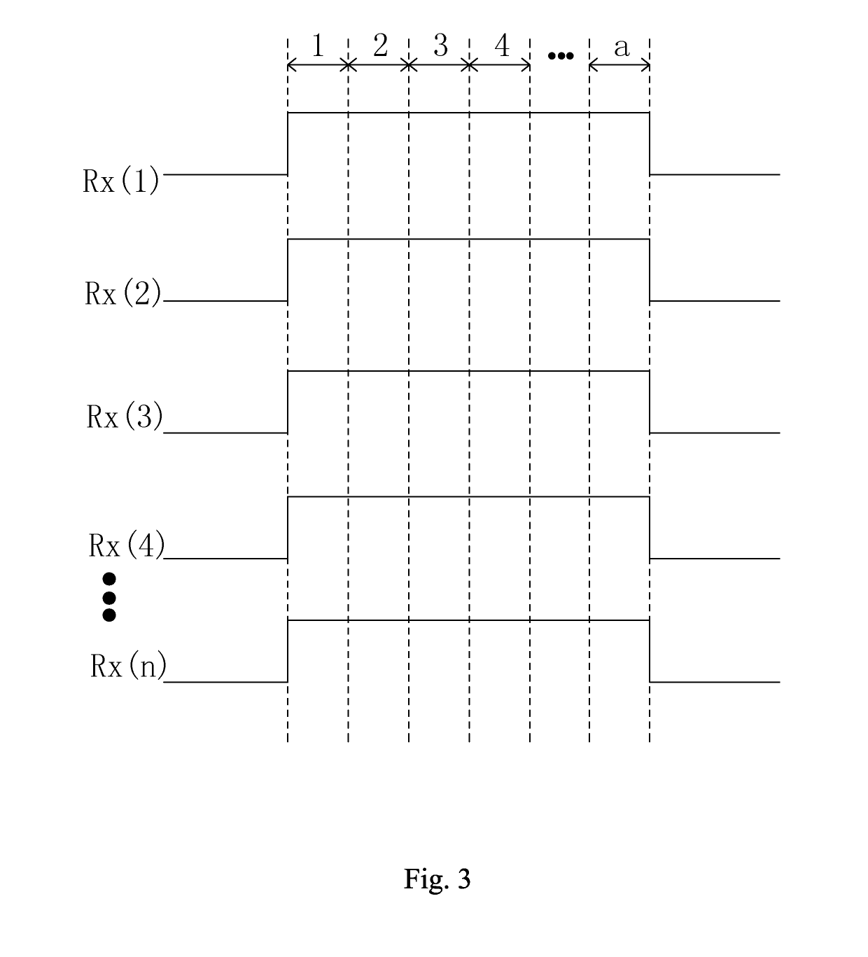

as a scan pulse signals Tx(1)-Tx(a) perform scan to the a driving lines, as shown in FIG. 3, each of a plurality of receiving lines Rx(1)-Rx(n) synchronously receives all the scan pulse signals provided by the a driving lines Tx(1)-Tx(a) to make that each of receiving lines Rx(1)-Rx(n) receives a receiving signal of the same signal value.

Specifically, the scan pulse signal is a high frequency signal; in the step 2, a sum of pulse durations of all the scan pulse signals is equal to a pulse duration of the receiving signal.

Significantly, the value of a can be designated according to the calculation and control abilities of the inner control chip of the touch control display panel. Supposing that the touch control display panel comprises thirty horizontal driving lines which are parallel with one another and sequentially aligned in total, i.e. m is designated to be 30, the signal generator can simultaneously generate two different scan pulse signals to perform scan to the two driving lines simultaneously, i.e. a is designated to be 2, and the scan is accomplished to all the thirty driving lines in 15 times. In comparison with the row-by-row scan according to prior art, the scan period can be shortened to ½ of the original period; the signal generator also can simultaneously generate five different scan pulse signals to perform scan to the five driving lines simultaneously, i.e. a is designated to be 5, and the scan is accomplished to all the thirty driving lines in 6 times. In comparison with the row-by-row scan according to prior art, the scan period can be shortened to ⅕ of the original period; the signal generator also can simultaneously generate ten different scan pulse signals to perform scan to the ten driving lines simultaneously, i.e. a is designated to be 10, and the scan is accomplished to all the thirty driving lines in 3 times. In comparison with the row-by-row scan according to prior art, the scan period can be shortened to 1/10 of the original period; the signal generator can even simultaneously generate 30 different scan pulse signals to perform scan to the thirty driving lines simultaneously, i.e. a is designated to be 30, and the scan is accomplished to all the thirty driving lines in 1 time. In comparison with the row-by-row scan according to prior art, the scan period can be shortened to 1/30 of the original period.

step 3, employing a control chip to decode the receiving signal received by each of the receiving lines Rx(1)-Rx(n) to acquire numbers of different scan pulse signals corresponding to different signal segment in the receiving signal. As shown in FIG. 3, after decoding the receiving signal, and in chronological order, the signal segment number of the scan pulse signal, which is numbered to be 1, corresponded with the receiving signal is 1, and the signal segment number of the scan pulse signal, which is numbered to be 2, corresponded with the receiving signal is 2, and until the signal segment number of the scan pulse signal, which is numbered to be a, corresponded with the receiving signal is a, i.e. the signal segment number of the scan pulse signal, which is numbered to be i, corresponded with the receiving signal is i, wherein 1≦i≦a.

step 4, as a finger touches the touch display panel, according to the numbers of the signal segment, of which the signal value becomes smaller, it is determined that the driving line corresponding to the number of the scan pulse signal is touched by the finger, and with combination of the receiving line corresponded with the receiving signal of the signal segment, of which the signal value becomes smaller, and then, an touch position can be acquired.

Specifically, as the finger touches a dot of the ith driving line Tx(i) and yth receiving line Rx(y), wherein 1≦i≦a, 1≦y≦n, the signal value of the signal segment which is numbered to be i, corresponded with the receiving signal received by the yth receiving line Rx(y) becomes smaller, and with the number i of the signal segment of which the signal value becomes smaller in the receiving signal, it is determined that what the finger touches is the ith driving signal line Tx(i) correspondingly providing the scan pulse signal, of which the number is i, and with combination of the yth receiving line Rx(y) corresponded with the receiving signal of the signal segment, of which the signal value becomes smaller, an touch position at the dot of the ith driving line Tx(i) and yth receiving line Rx(y) is acquired.

Furthermore, in the step 4, the signal value of the signal segment, which is numbered to be i, corresponded with the receiving signal of the yth receiving line Rx(y) becomes smaller because the capacitance of the dot becomes smaller when the finger touches the dot of the ith driving line Tx(i) and the yth receiving line Rx(y).

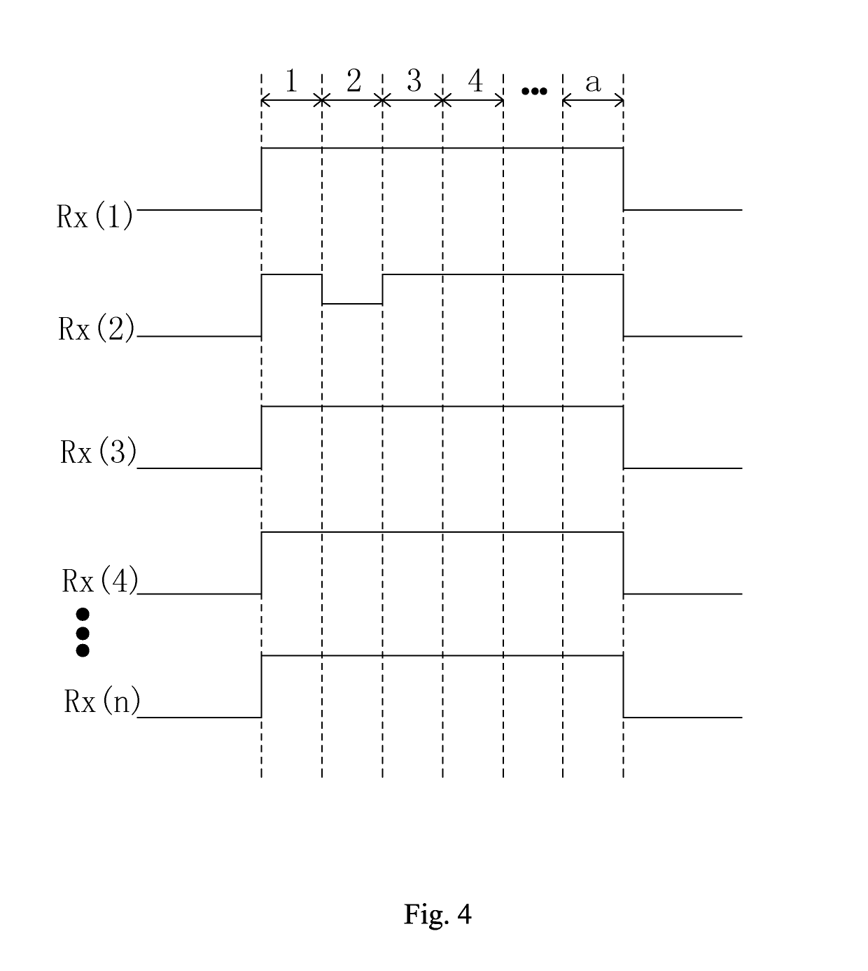

As illustrated in FIG. 4, as the finger touches the dot of the second driving line Tx(2) and the second receiving line Rx(2), the signal value of the signal segment which is numbered to be 2, corresponded with the receiving signal received by the second receiving line Rx(2) becomes smaller, and with the number 2 of the signal segment of which the signal value becomes smaller in the receiving signal, it is determined that what the finger touches is the second driving signal line Tx(2) correspondingly providing the scan pulse signal, of which the number is 2, and with combination of the second receiving line Rx(2) corresponded with the receiving signal of the signal segment, of which the signal value becomes smaller, an touch position at the dot of the second driving line Tx(2) and the second receiving line Rx(2) can be acquired.

In conclusion, the present invention provides a scan method of a touch signal. The different scan pulse signals with an amount corresponding to a plurality of driving lines are employed to perform scan simultaneously, and a corresponding coding is performed to each scan pulse signal; meanwhile, each of a plurality of receiving lines synchronously receives all the scan pulse signals provided by the plurality of driving lines, and a control chip is employed to decode the receiving signal received by each of the plurality of receiving lines to determine the sources of the different signal segments in the receiving signal; as the finger touches, it is determined that the driving line corresponding to the number of the scan pulse signal is touched by the finger, and with combination of the receiving line corresponded with the receiving signal of the signal segment, of which the signal value becomes smaller, an touch position is acquired. The method can decrease an occupied period of performing scan to a touch signal by an In Cell touch control display device to increase the period of display signal scan for urging the In Cell touch control display device to be developed with higher resolution.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A scan method of a touch signal, comprising steps of:
step 1, providing a touch display panel;
the touch display panel comprises m horizontal driving lines which are parallel with one another and sequentially aligned, and n vertical receiving lines which are parallel with one another and sequentially aligned, wherein both m, n are integers larger than 2;
step 2, employing a signal generator to simultaneously generate a different scan pulse signals to perform scan to the a driving lines simultaneously, wherein 2≦a≦m, and a falling edge of the scan pulse signal corresponding to the previous driving line and a rising edge of the scan pulse signal corresponding to the next driving line are simultaneously generated, and a corresponding coding is performed to each scan pulse signal;
as the a scan pulse signals perform scan to the a driving lines simultaneously, all the receiving lines synchronously receives all the scan pulse signals provided by the a driving lines to make that each receiving line receives a receiving signal of the same signal value;
step 3, employing a control chip to decode the receiving signal received by each receiving line to acquire numbers of different scan pulse signals corresponding to different signal segment in the receiving signal;
step 4, as a finger touches the touch display panel, according to the numbers of the signal segment, of which the signal value becomes smaller, it is determined that the driving line corresponding to the number of the scan pulse signal is touched by the finger, and with combination of the receiving line corresponded with the receiving signal of the signal segment, of which the signal value becomes smaller, an touch position is acquired.

2. The scan method of the touch signal according to claim 1, wherein in the step 2, the scan pulse signal corresponding to ith driving line is numbered to be i, wherein 1≦i≦a.

3. The scan method of the touch signal according to claim 2, wherein in the step 2, a sum of pulse durations of all the scan pulse signals is equal to a pulse duration of the receiving signal.

4. The scan method of the touch signal according to claim 3, wherein in the step 3, in chronological order, the signal segment number of the scan pulse signal, which is numbered to be i, corresponded with the receiving signal is i.

5. The scan method of the touch signal according to claim 4, wherein a specific process of the step 4 is: as the finger touches a dot of the ith driving line and yth receiving line, wherein 1≦y≦n, the signal value of the signal segment which is numbered to be i, corresponded with the receiving signal received by the yth receiving line becomes smaller, and with the number i of the signal segment of which the signal value becomes smaller in the receiving signal, it is determined that what the finger touches is the ith driving signal line correspondingly providing the scan pulse signal, of which the number is i, and with combination of the yth receiving line corresponded with the receiving signal of the signal segment, of which the signal value becomes smaller, an touch position at the dot of the ith driving line and yth receiving line is acquired.

6. The scan method of the touch signal according to claim 1, wherein both the driving lines and the receiving lines are formed at common electrode layer.

7. The scan method of the touch signal according to claim 1, wherein the driving lines are formed at common electrode layer, and the receiving lines are formed at another metal layer, which is not the common electrode layer.

8. The scan method of the touch signal according to claim 1, wherein the scan pulse signal is a high frequency signal.

9. The scan method of the touch signal according to claim 1, wherein the touch display panel is an In Cell type touch display panel.

10. The scan method of the touch signal according to claim 1, wherein the touch display panel is a mutual capacitance type touch display panel.

11. A scan method of a touch signal, comprising steps of:
step 1, providing a touch display panel;
the touch display panel comprises m horizontal driving lines which are parallel with one another and sequentially aligned, and n vertical receiving lines which are parallel with one another and sequentially aligned, wherein both m, n are integers larger than 2;
step 2, employing a signal generator to simultaneously generate a different scan pulse signals to perform scan to the a driving lines simultaneously, wherein 2≦a≦m, and a falling edge of the scan pulse signal corresponding to the previous driving line and a rising edge of the scan pulse signal corresponding to the next driving line are simultaneously generated, and a corresponding coding is performed to each scan pulse signal;
as the a scan pulse signals perform scan to the a driving lines simultaneously, all the receiving lines synchronously receives all the scan pulse signals provided by the a driving lines to make that each receiving line receives a receiving signal of the same signal value;
step 3, employing a control chip to decode the receiving signal received by each receiving line to acquire numbers of different scan pulse signals corresponding to different signal segment in the receiving signal;
step 4, as a finger touches the touch display panel, according to the numbers of the signal segment, of which the signal value becomes smaller, it is determined that the driving line corresponding to the number of the scan pulse signal is touched by the finger, and with combination of the receiving line corresponded with the receiving signal of the signal segment, of which the signal value becomes smaller, an touch position is acquired;
wherein in the step 2, the scan pulse signal corresponding to ith driving line is numbered to be i, wherein 1≦i≦a;
wherein the touch display panel is an In Cell type touch display panel;
wherein the touch display panel is a mutual capacitance type touch display panel.

12. The scan method of the touch signal according to claim 11, wherein in the step 2, a sum of pulse durations of all the scan pulse signals is equal to a pulse duration of the receiving signal.

13. The scan method of the touch signal according to claim 12, wherein in the step 3, in chronological order, the signal segment number of the scan pulse signal, which is numbered to be i, corresponded with the receiving signal is i.

14. The scan method of the touch signal according to claim 13, wherein a specific process of the step 4 is: as the finger touches a dot of the ith driving line and yth receiving line, wherein 1≦y≦n, the signal value of the signal segment which is numbered to be i, corresponded with the receiving signal received by the yth receiving line becomes smaller, and with the number i of the signal segment of which the signal value becomes smaller in the receiving signal, it is determined that what the finger touches is the ith driving signal line correspondingly providing the scan pulse signal, of which the number is i, and with combination of the yth receiving line corresponded with the receiving signal of the signal segment, of which the signal value becomes smaller, an touch position at the dot of the ith driving line and yth receiving line is acquired.

15. The scan method of the touch signal according to claim 11, wherein both the driving lines and the receiving lines are formed at common electrode layer.

16. The scan method of the touch signal according to claim 11, wherein the driving lines are formed at common electrode layer, and the receiving lines are formed at another metal layer, which is not the common electrode layer.

17. The scan method of the touch signal according to claim 11, wherein the scan pulse signal is a high frequency signal.
